(19) United States
(12) Patent Application Publication
(10) Pub. No.: US 2010/0305886 A1
(43) Pub. Date: Dec. 2, 2010

(54) Kurtosis Regulating Vibration Controller Apparatus and Method

(75) Inventor: James Zhuge, Palo Alto, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: BRUEL & KJAER, SOUND & VIBRATION MEASUREMENT A/S, Naerum (DK)

(21) Appl. No.: 12/789,702

(22) Filed: May 28, 2010

Related U.S. Application Data
(60) Provisional application No. 61/182,894, filed on Jun. 1, 2009.

(51) Int. Cl. G06F 19/00; G01N 29/12; G06F 17/18

(52) U.S. Cl. 702/56; 700/275; 702/179

(57) ABSTRACT

A vibration control system provides a user-specified value of kurtosis as well as user control over a baseline random spectral density profile. The baseline random spectral density profile and a signal that embeds the desired value of kurtosis are summed in the frequency domain prior to forming a time-domain output waveform that drives a vibration table with attached unit under test. Feedback from a sense transducer attached to the vibration table or the unit under test measures the as-realized vibration's random spectral density and kurtosis value, which are then compared to the desired values to allow correction.

### FIELD OF THE INVENTION

The present invention relates generally to systems for driving and/or controlling a vibration table. More specifically, the invention relates to methods and apparatus that control a vibration table with a signal that controls the frequency content and statistical fourth moment, or kurtosis value, for example, of the vibration table.

### BACKGROUND OF THE INVENTION

Vibratory testing of products is a component of product development and manufacturing. Vibration testing is used to determine product integrity in anticipation of environmental stresses from transportation and in-use environment, for example. Specifically, a global positioning system (GPS) device, for example, will likely be subjected to a variety of vibration environments, such as during shipment from manufacturer to customer. If the GPS device is then mounted in a vehicle it will be subjected to additional, different vibration environments as the vehicle is driven over roads, road hazards, and open terrain, for example. Random vibration testing is a test method that reproduced a wide range of real-world environments, such as the different vibration environments described above, for example. A frequency content of the random vibration can be tailored to approximate a specific real-world environment that a product will experience.

Typical random vibration tests use signals that have a Gaussian (also termed normal) distribution. A Gaussian random signal is characterized in the amplitude domain by a continuous probability distribution, where the signal values cluster around the mean signal value. The probability of occurrence of a signal at a particular value (for continuous probability distributions) or within a particular “bin,” i.e., one of a plurality of discrete subsets of a value range (for discrete probability distributions), decreases with the distance of that value or bin from the mean (or center) value.

Mathematically, some of the low-order central moments of probability distributions characterize the random signal properties. The first central moment about the mean is zero. The second central moment is the variance (the square of the standard deviation). The third central moment can be referred to as skewness, or asymmetry of distribution below (versus above) the mean. The fourth central moment, kurtosis, is a measure of the “peakedness” of the probability distribution. A random signal with high kurtosis will have a variance, due more to infrequent extreme deviations from the mean value, that is, those values in the tails of the distribution, than to frequent deviations closer to the mean value.

Kurtosis is a scalar value, also defined as the fourth cumulant divided by the second cumulant, which is equal to the fourth moment around the mean divided by the square of the variance of the probability distribution. As used herein, “zero excess kurtosis” means a kurtosis of 3. This kurtosis value corresponds to a normal distribution.

Kurtosis quantifies the probability of occurrence of value excursions outside a smooth distribution. This may be observed in a time-domain graph as the presence of occasional spikes or flat spots in an otherwise uniform-appearing noise signal. For example, in vibration testing of a car roof rack, use of a random spectrum having a strictly normal probability distribution would not account for specific vibration stresses due to potholes, speed bumps, or railroad tracks, etc. Increasing the magnitude of kurtosis in a vibratory apparatus can establish more realistic testing models and more useful process mechanisms.

What is needed is an apparatus or method that can realize and control a random signal with a particular spectral distribution and a particular value of kurtosis in a vibratory test system that includes an actuator, a unit under test, and a system controller.

### SUMMARY OF THE INVENTION

The above needs are met by apparatus and methods in accordance with the present invention, wherein a vibration controller includes a user-selectable kurtosis level in a random vibration test system.

In one aspect of the invention, a controlled-kurtosis vibration controller that provides an excitation random signal to an actuator in response to an input from a motion transducer is presented. The vibration controller includes a Gaussian spectrum generator that generates a frequency-domain Gaussian distributed random spectrum.

The vibration controller further includes a non-Gaussian spectrum generator that generates a frequency-domain non-Gaussian distributed random spectrum. The non-Gaussian spectrum generator receives an input signal based on the input from the motion transducer, generates a scalar kurtosis estimate from the input signal, and compares the scalar kurtosis estimate to a target value. A result of the comparison is used to generate a time-domain envelope with attributes including amplitudes-of-transients and numbers-of-transients. The time-domain envelope is used to modulate a time-domain random signal. The non-Gaussian spectrum generator also transforms the modulated time-domain random signal into a frequency-domain non-Gaussian distributed random spectrum.

The vibration controller further includes an inverse transfer function generator that modulates the respective spectra from the Gaussian and non-Gaussian spectrum generators. The inverse transfer function generator receives the input signal and frequency-domain transforms the input signal into an input spectrum. The inverse transfer function generator further receives a vibration controller output drive signal and frequency-domain transforms the vibration controller output drive signal into an output drive spectrum. The input spectrum and the output drive spectrum are processed to produce an estimate of cross power spectrum density. The output drive spectrum is processed to produce an estimate of auto power spectrum density. The estimate of cross power spectrum density and the estimate of auto power spectrum density are respectively averaged, and the respective averages are divided to generate a frequency-domain inverse transfer function.

The vibration controller further includes a synthesizer that generates the vibration controller output drive signal. The Gaussian and non-Gaussian spectra are respectively multiplied by the frequency-domain inverse transfer function, and the respective multiplier outputs are summed and transformed into the vibration controller output drive signal, which is fed back to the actuator as the excitation random signal.

In another aspect, a vibration test system is presented. The vibration test system includes a vibration table, a unit under test disposed on the vibration table, a transducer operably connected to the unit under test, and a controlled-kurtosis controller.

The controlled-kurtosis controller includes a Gaussian spectrum generator that generates a frequency-domain Gaussian distributed random spectrum, a non-Gaussian spectrum generator that generates a frequency-domain non-Gaussian distributed random spectrum, an inverse transfer function generator that modulates the respective spectra from the Gaussian and non-Gaussian spectrum generators, and a synthesizer that generates the vibration controller output drive signal.

The non-Gaussian spectrum generator receives an input signal based on an input from the transducer, generates a scalar kurtosis estimate from an input signal from the transducer, compares the scalar kurtosis estimate to a target value, uses a result of the comparison to generate a time-domain envelope with attributes including amplitudes-of-transients and numbers-of-transients, uses the time-domain envelope to modulate a time-domain random signal, and transforms the modulated time-domain random signal into a frequency-domain non-Gaussian distributed random spectrum.

The inverse transfer function generator receives the input signal and frequency-domain transforms the input signal into an input spectrum. The inverse transfer function generator receives a vibration controller output drive signal and frequency-domain transforms the vibration controller output drive signal into an output drive spectrum. The input spectrum and the output drive spectrum are processed to produce an estimate of cross power spectrum density. The output drive spectrum is processed to produce an estimate of auto power spectrum density. The estimate of cross power spectrum density and the estimate of auto power spectrum density are respectively averaged, and the respective averages are divided to generate a frequency-domain inverse transfer function.

The Gaussian and non-Gaussian spectra are respectively multiplied by the frequency-domain inverse transfer function, and the respective multiplier outputs are summed and transformed into the vibration controller output drive signal, which is fed back to the vibration table as the excitation random signal.

In another aspect, a method of providing an excitation random signal to an actuator in response to an input from a motion transducer is presented. The method includes generating a frequency-domain Gaussian distributed random spectrum, generating a frequency-domain non-Gaussian distributed random spectrum, modulating the respective Gaussian and non-Gaussian spectra, and generating the vibration controller output drive signal.

Generating the frequency-domain non-Gaussian distributed random spectrum further includes receiving an input signal based on the input from the motion transducer, generating a scalar kurtosis estimate from the input signal, comparing the scalar kurtosis estimate to a target value, using result of the comparison to generate a time-domain envelope with attributes including amplitudes-of-transients and numbers-of-transients, using the time-domain envelope to modulate a time-domain random signal, and transforming the modulated time-domain random signal into a frequency-domain non-Gaussian distributed random spectrum.

Modulating the respective Gaussian and non-Gaussian spectra further includes receiving the input signal and frequency-domain transforming the input signal into an input spectrum, receiving a vibration controller output drive signal and frequency-domain transforming the vibration controller output drive signal into an output drive spectrum, processing the input spectrum and the output drive spectrum processed to produce an estimate of cross power spectrum density, processing the output drive spectrum to produce an estimate of auto power spectrum density, averaging the estimate of cross power spectrum density and the estimate of auto power spectrum density, and dividing the respective averages to generate a frequency-domain inverse transfer function.

In generating the vibration controller output drive signal, the Gaussian and non-Gaussian spectra are respectively multiplied by the frequency-domain inverse transfer function, and the respective multiplier outputs are summed and transformed into the vibration controller output drive signal. The vibration controller output drive signal is fed back to the actuator as the excitation random signal.

There have thus been outlined, rather broadly, example features and aspects of the invention, in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. It is also to be understood that the phraseology and terminology employed herein, as well as in the abstract, are for the purpose of description, and should not be regarded as limiting.

As such, those of ordinary skill in the art will readily appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWING

FIG. 1 is a block diagram of a vibration test transducer and actuator controller according to the present invention.

### DETAILED DESCRIPTION

The invention will now be described with reference to the drawing FIGURE, in which like reference numerals refer to like elements throughout. An embodiment in accordance with the present invention provides a random signal of sufficient power to excite a selected vibration test fixture to the desired test levels, and further provides a user-selected level of kurtosis in the signal as verified by measuring the motion of the fixture. The kurtosis component is controlled dynamically by calculating the achieved kurtosis magnitude during successive time intervals, comparing each such value to a user setting for kurtosis, and generating successive revised kurtosis signal patterns, each modified as needed to offset residual error detected in preceding intervals.

Representative contemporary vibratory equipment uses a power amplifier, commonly electronic or hydraulic, driving an actuator that moves a vibration table. Electrodynamic coils and hydraulic actuators under electronic control can be suitable for applying a variety of force levels up to multiple tons.

A time-domain signal that describes the excursion of a transducer during a sampling period may be transformed to and from a frequency-domain representation using classical Fourier transformations, approximated by the well-known fast Fourier transform (FFT) and its inverse (iFFT). Terms of the FFT output include a set of “bins” over a frequency span into which a spectrum is divided. The spectral energy represented by the relative magnitudes of values in the bins correlates to the original time signal, and can be transformed back and forth repeatedly with little loss of significance. It is to be understood that an iFFT of a spectrum creates a time-domain signal.

Terms “Gaussian” and “non-Gaussian” as used herein refer to properties of random and pseudorandom time domain event sequences. Such sequences can be captured by transducers or synthesized. In digital form, the sequences can be represented as successions of data samples, also termed signals. Time-windowed frequency-domain transforms of these signals may be viewed as having spectral content, including power spectra. For brevity, the frequency-domain transforms of Gaussian and non-Gaussian event sequences, data samples, or signals are referred to herein as Gaussian and non-Gaussian spectra, random spectra, or distributed random spectra.

In the discussion below, the shorthand notations (t) and (f) signify that the phenomenon under discussion at that moment is “of time” and “of frequency,” respectively. Time-domain data, in order to be transformable to frequency-domain data, are captured as sequences of digitized values during time windows. Such windows may have rectangular (“boxcar”) boundaries, or may be weighted using variable gain profiles across the time window; such gain profiles include Hamming, Hann, sin²x, raised cosine, and numerous others. The data blocks can be FFT-converted to the frequency domain, which preserves the spectral distribution of energy. Similarly, a spectral distribution can be converted to a time data stream by an iFFT, using a pseudorandom number generator to generate random phase characteristics. Some well-implemented pseudorandom sources permit any number of iFFT outputs from the same spectral data to be uncorrelated in the time domain but spectrally identical.

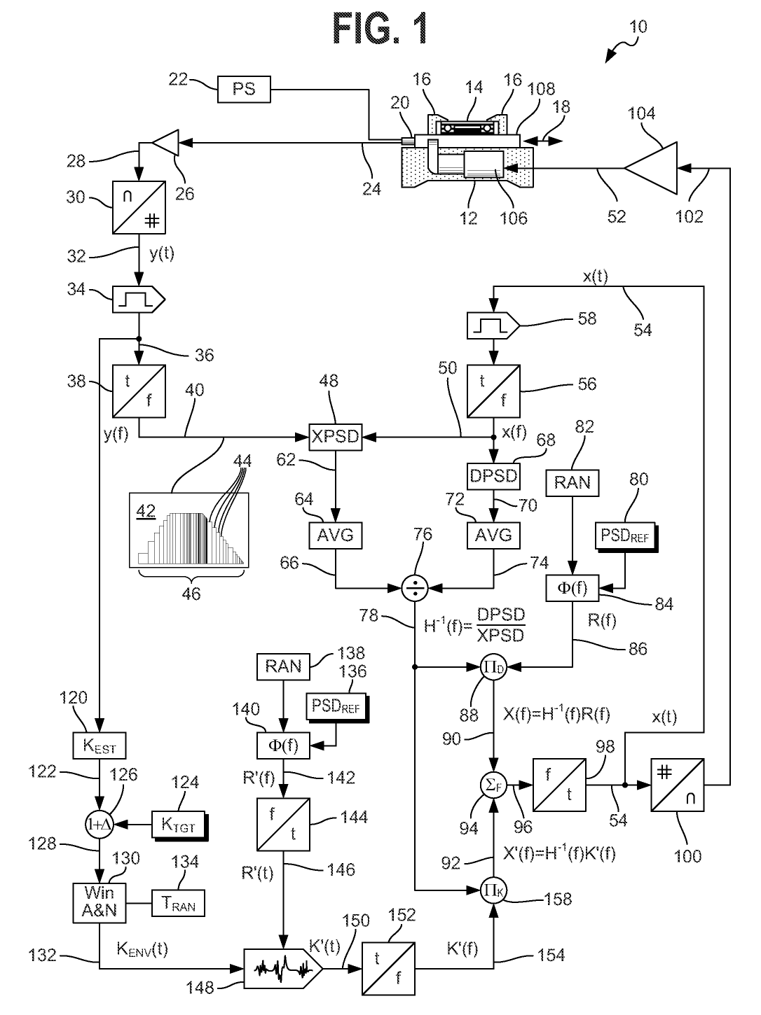

FIG. 1 shows a vibration test system 10 in block diagram form. Typically, the functional blocks within the diagram can be realized by dedicated electronic circuitry, by digital signal processing functional units configurable to execute the functions when so directed, or by analogous apparatus. The blocks can also be realized by software created to execute the individual functions represented by the blocks when loaded from storage media into execution-capable parts of a general-purpose computer. Certain functional blocks, such as input and output interface functions, generally use dedicated electronic circuitry that can be incorporated into a single-purpose or general-purpose controller in order to enable interaction with external devices. Distinction between dedicated hardware and optional software/firmware/hardware functional blocks may be explicit or implicit herein.

The system 10 in one or more example embodiments ordinarily executes in a continuous loop. Operation of the complete control loop is described with respect to an arbitrary functional starting point, a fixture fitted with a unit under test, a vibration table and power amplifier, and a motion sensor, e.g., a motion transducer, all external to a vibration controller within the system 10.

A vibration test stand, generally referred to herein as a vibration table 12, may have a unit under test (UUT) 14 attached thereto by appropriate mechanisms, such as mechanical clamps or fasteners 16. Such a table 12 may be of any desired size and conformation. Motion may be along one or more translational axes, horizontal or otherwise, or about rotational axes, vertical or otherwise. For simplicity, it may be assumed that the table 12 accepts a UUT 14 roughly the size of an automobile radio, and is free to move with minimal constraint with a single degree of freedom, namely back-and-forth along a test axis 18, at a time. None of the above attributes of the vibration table should be viewed as limiting; for example, a UUT 14 may be smaller than a transistor or larger than a truck, given appropriately-sized test apparatus.

A single sense transducer 20, shown mounted to the table 12, although optionally mounted to the UUT 14 in other embodiments, measures vibration aligned with the test axis 18. A representative transducer 20 is an accelerometer, such as a solid-state reactive component having a property, such as capacitance, that is able to change in response to motion of an integral microelectromechanical system. Such a transducer 20 senses and converts mechanical motion into an electrical signal that is proportional to the motion of the UUT 14, with an excursion in amplitude determined by the magnitude of the instantaneous motion. Numerous other types of transducers 20 may be applied, capable of measuring a parameter such as displacement, velocity, acceleration, jerk, or a rotational equivalent of one of these, using many alternative telemetry schemes. Where desired, any of these parameters can be integrated or differentiated to provide a data stream for use in an example embodiment of a system 10.

In other example embodiments, more than one transducer 20 or a single transducer 20 configured for detection along or about more than one axis 18 may be provided. In these cases, vibration test system operation may be controlled jointly or independently for each degree of freedom allowed by the table 12 and sensed by the transducer(s) 20.

Assuming a single-axis accelerometer as the transducer 20 and a controller configured to operate in an acceleration space, the signal from the transducer 20, with appropriate signal conditioning and power 22 as needed, is presented as an input 24 to a front-end (input signal) buffer circuit 26 in the controller 10. Such a buffer 26 may incorporate demodulating, passive filtering, and/or other signal conditioning (not shown separately), such as attenuating offset bias, out-of-band noise, and the like.

The transducer 20 may instead provide a digital data bit stream output by user preference. Where the transducer 20 is analog, a buffer output signal 28 is digitized to provide a stream of numerical values over a desired range using an input analog to digital converter (Input A/D) 30 as shown. The remainder of the signal path up to the output digital to analog converter (Output D/A) 100 is digital in example embodiments. The digitized output of the Input A/D 30, termed y(t) 32, is then fed to two analysis functions. A first of these accepts the y(t) 32 data and partitions it 34 into time windowed data blocks that may overlap to any extent. The windowed data 36 is processed with a first time-domain-to-frequency-domain converter 38, realized in some embodiments using a fast Fourier transform (FFT) process. The FFT output, termed y(f) 40, includes a sense signal power spectrum, as shown in insert chart 42, partitioned into a plurality of so-named frequency bins 44 over the frequency range of interest 46. Successive y(f) 40 outputs may be based on overlapping or successive time windows, as dictated by user preference.

The y(f) 40 output is directed to a cross-power spectrum combiner 48. The second input of the combiner 48 is an FFT representation x(f) 50 of the final drive output 52, to be directed to power the vibration table 12. As shown, x(f) 50 is converted from a time-domain digital command signal x(t) 54 by another FFT process 56, with the signal x(t) 54 having been windowed 58. Windowing limitations can be comparable to those that the windowing function 34 applied to the digitized sense signal y(t) 32 data stream, with the inclusion of such time delay as may be needed to synchronize the command signal x(t) 54 with the sense signal y(t) 32 from the transducer 20. The two frequency-domain signals y(f) 40 and x(f) 50, combined 48 as noted, provide successive cross-power spectral density estimations XPSD 62. The XPSD 62 estimates from successive windows can be averaged 64 bin by bin to provide a rolling cross spectrum 66. The output drive spectrum x(f) 50 can also be processed alone 68 to provide drive auto-PSD estimations DPSD 70. Like the XPSD 62 estimates, the DPSD 70 estimates from successive windows can be averaged 72 bin by bin, providing a rolling drive power spectrum 74.

The bin values within the averaged cross power spectrum 66, divided 76 into the respective bin values within the averaged auto power spectrum 74, generate a rolling inverse transfer function H⁻¹ (f) 78. A reference PSD spectrum PSD_{REF} 80, a fixed data set which may have any selected spectral distribution, such as an expected energy distribution for a test environment free of excess kurtosis (e.g., Gaussian random), along with a phase randomizer 82, provides baseline properties for a phase-randomized spectrum source Φ(f) 84. The output R(f) 86 of the spectrum source Φ(f) 84, multiplied Π_{D} 88 by the inverse transfer function H⁻¹(f) 78, provides a frequency-domain output X(f) 90.

As noted above, the digitized, windowed time-domain signal y(t) 36 is also processed in a second analysis function, termed kurtosis control, further discussed below. The output of the kurtosis control function, having a value X′(f) 92, is summed by a summer Σ_{F} 94 with the signal X(f) 90. This sum 96 is inverse-FFT (iFFT) processed 98 to provide the time domain digital drive stream x(t) 54, referenced above. The x(t) 54 signal is then converted to analog in the embodiment shown, using an output digital-to-analog converter (Output D/A) 100, of which the low-level analog output excitation signal 102 is applied to a driver circuit 104 of appropriate power output to generate the above-referenced final analog output signal 52. The final analog output signal 52 is applied to a driver actuator 106 coupled to the movable portion 108 of the vibration table 12.

It is to be understood that the conversion of the digital time-domain signal x(t) 54 to a low-level analog excitation signal 102 by an Output D/A 100, followed by boosting thereof with a driver circuit 104, typically an external device matched to the size of the vibration table 12, are steps specific to some embodiments, and may be either redundant or merged in other embodiments. For example, a driver circuit 104 having sufficient output to power a specific actuator 106 may accept a digital input x(t) 54 at the level implied—typically internal logic levels within computational devices, optionally buffered using a digital interface such as Universal Serial Bus (USB) or the earlier serial bus RS-232—or an analog excitation signal may have appropriate parameters to drive the front end of an amplifier separate from or integral with a vibration table 12, functioning as the driver circuit 104 shown in FIG. 1.

Actuator technologies akin to loudspeaker voice coils, as well as electronically-controlled hydraulically- and pneumatically-powered rams and other technologies, are suited to realizing driver actuators 106, as dictated by load inertia and spectral response fidelity criteria of individual applications. Thus, any combination of electronic and non-electronic signal boosting may be included in the driver circuit 104, while the driver actuator 106 may be of any technology selected for a particular embodiment.

FIG. 1 further provides illustration of the kurtosis control function. The windowed time domain signal y(t) 36 is analyzed by a kurtosis estimator K_{EST} 120 to supply a momentary kurtosis value 122. The momentary kurtosis value 122 is a scalar, either a floating-point number in the range 3.00 to 7.00 (in some kurtosis models the range may begin at zero; in others there is no upper bound) or a fixed-point value or other format providing an equivalent working range, as dictated by details of implementation. The estimator K_{EST} 120 may develop momentary kurtosis values 122 that are computed, smoothed, averaged, and the like over selected time periods, so that the variance of the kurtosis estimates falls within an acceptable range. The window 34 rate used for capturing y(t) 32 is selected to support useful and timely kurtosis estimation.

A target kurtosis K_{TGT} value 124 is provided by the operator as a step in the use of example embodiments. A comparator 126 calculates the algebraic difference between the K_{TGT} value 124 and the K_{EST} momentary value 122 as the momentary K correction factor 128. A Window A & N function 130 generates a time-domain kurtosis envelope K_{ENV}(t) 132 with particular amplitudes (A) and numbers of transients (N) occurring at time intervals controlled by a time delay randomizer T_{RAN} 134, the latter configured to suppress system periodicity artifacts. For example, with zero realized K_{EST} 122, comparator output 128 should exceed K_{TGT} 124 to increase K_{ENV} 132. For increasing K_{EST} 122, output 128 should decrease. For K_{EST} 122 equal to K_{TGT} 124, output 128 should cause K_{ENV} 132 to be sufficient to cause K_{EST} 122 and K_{TGT} 124 to track. For K_{EST} 122 greater than K_{TGT} 124, output 128 should similarly decrease. Thus, the comparator 126 is labeled “1+Δ” to suggest the general range of the result.

A reference spectrum PSD_{REF} 136, either duplicating the reference random spectrum PSD_{REF} 80 above or, in another example embodiment, differing from it, is applied along with a signal from phase randomizer RAN 138 as inputs to a random spectrum source Φ(f) 140 that provides a reference spectrum R′(f) 142. This spectrum R′(f) 142 is applied to an iFFT function 144, the output of which is a time-domain random signal R′(t) 146.

The R′(t) 146 random signal is windowed 148 using the kurtosis envelope K_{ENV}(t) 132 derived from the corrected kurtosis signal. The output K′(t) 150 of the windowing function 148 is thus a random noise signal within the envelope defined by the corrected kurtosis, and is zero at all other times. This signal K′(t) 150 is applied to another FFT function 152, the output of which, K′(f) 154, thus represents a kurtosis spectrum. The kurtosis control function that accepts a windowed time domain signal y(t) 36 and produces a frequency-domain kurtosis output K′(f) 154 is termed a frequency-domain kurtosis signal generation function.

The frequency-domain kurtosis spectrum K′(f) 154 is multiplied Π_{K} 158 by the inverse transfer function H⁻¹ (f) 78, providing a drive-compensated version of the kurtosis component. As described above, this product term XV) 92 is then summed 94 with the drive-compensated non-kurtosis component X(f) 90 in the frequency domain, then iFFT transformed 98 to the time domain to provide the final drive signal x(t) in digital 54 and analog 102 form.

The inverse transfer function H⁻¹ (f) 78 compensates for the measured load dynamics (feedback 24 from the driven vibration table 12)—that is, the vibration controller does instantaneous frequency-domain adjustments to the frequency domain drive spectrum proportional to changes in the product of the inverse transfer function and the desired target profile PSD_{REF} 80. The inverse transfer function H⁻¹ (f) 78 is applied to a user-specified reference spectrum R(f) 86, which may have any desired spectral profile. The product function Π_{D} 88 defines a compensated spectrum X(f) 90 without excess kurtosis.

The inverse transfer function H⁻¹ (f) 78 is likewise applied to the output K′(f) 154 of the kurtosis control function. The product function Π_{K} 158 provides a spectrum X′(f) 92 precompensated for errors in achieved kurtosis in the motion of the vibration table 12.

Note that the reference spectra PSD_{REF} 80, 136 are data sets, and can remain constant over a test interval, while the phase randomizers RAN 82, 138 that establish R(f) 86, R′(f) 142, as well as the compensation transfer function H⁻¹(f) that operates on R(f), R′(f) are repeatedly/continuously redefined, so that the compensated spectra X(f), X′(f) can be likewise repeatedly/continuously redefined.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A controlled-kurtosis vibration controller which provides an excitation random signal to an actuator in response to an input from a motion transducer, the controlled-kurtosis vibration controller comprising:
a Gaussian spectrum generator which generates a frequency-domain Gaussian distributed random spectrum;
a non-Gaussian spectrum generator which generates a frequency-domain non-Gaussian distributed random spectrum, wherein the non-Gaussian spectrum generator receives an input signal based on the input from the motion transducer, generates a scalar kurtosis estimate from the input signal, compares the scalar kurtosis estimate to a target value, uses a result of the comparison to generate a time-domain envelope with attributes including amplitudes-of-transients and numbers-of-transients, uses the time-domain envelope to modulate a time-domain random signal, and transforms the modulated time-domain random signal into a frequency-domain non-Gaussian distributed random spectrum;
an inverse transfer function generator which modulates the respective spectra from the Gaussian and non-Gaussian spectrum generators, wherein the inverse transfer function generator receives the input signal and frequency-domain transforms the input signal into an input spectrum, the inverse transfer function generator receives a vibration controller output drive signal and frequency-domain transforms the vibration controller output drive signal into an output drive spectrum, the input spectrum and the output drive spectrum are processed to produce an estimate of cross power spectrum density, the output drive spectrum is processed to produce an estimate of drive auto power spectrum density, the estimate of cross power spectrum density and the estimate of drive auto power spectrum density are respectively averaged, and the respective averages are divided to generate a frequency-domain inverse transfer function; and
a synthesizer which generates the vibration controller output drive signal, wherein the Gaussian and non-Gaussian spectra are respectively multiplied by the frequency-domain inverse transfer function, and the respective multiplier outputs are summed and transformed into the vibration controller output drive signal, which is fed back to the actuator as the excitation random signal.

2. The controlled-kurtosis vibration controller of claim 1, wherein
the motion transducer is mounted to a movable portion,
a unit under test is disposed on the movable portion, and
the motion transducer generates the input signal based on movement of the unit under test along at least one test axis.

3. The controlled-kurtosis vibration controller of claim 1, wherein the inverse transfer function generator comprises:
a generator which receives the input signal and generates the input spectrum;
a generator which receives the vibration controller output drive signal and generates the output drive spectrum;
a cross power random spectrum estimator which receives the input spectrum and the output drive spectrum and generates the estimate of cross power spectrum density; and
an averaging function for successive estimates of cross power spectrum density.

4. The controlled-kurtosis vibration controller of claim 3, wherein the inverse transfer function generator further comprises:
a drive auto-power random spectrum estimator, which receives the output drive spectrum and generates the estimate of drive auto-power spectrum density;
an averaging function for successive estimates of cross power spectrum density; and
a divider which receives averaged estimates of cross power spectrum density and drive auto-power spectrum density and computes successive ratios thereof.

5. The controlled-kurtosis vibration controller of claim 1, wherein the Gaussian spectrum generator comprises a phase randomizer.

6. The controlled-kurtosis vibration controller of claim 1, wherein the non-Gaussian spectrum generator comprises:
a generator which generates the time-domain random signal;
a generator which generates the time-domain envelope, wherein an instantaneous envelope amplitude of the generator output is proportional to a deviation between the scalar kurtosis estimate and a target kurtosis value; and
a generator which generates the non-Gaussian spectrum, wherein the reference random signal, windowed by the time-domain envelope, is transformed from the time domain to the frequency domain.

7. The controlled-kurtosis vibration controller of claim 1, further comprising:
a summer which sums the Gaussian random spectrum and the non-Gaussian random spectrum, the Gaussian random spectrum being a product of the frequency-domain inverse transfer function and the frequency-domain Gaussian distributed random spectrum, and the non-Gaussian spectrum being a product of the frequency-domain inverse transfer function and the frequency-domain non-Gaussian distributed random spectrum; and
an output digital-to-analog converter which outputs a time-domain analog excitation signal.

8. The controlled-kurtosis vibration controller of claim 1, further comprising an input signal buffer circuit connected to the motion transducer.

9. The controlled-kurtosis vibration controller of claim 1, further comprising at least one phase randomizer which outputs one of a frequency-domain random signal and a time-domain random signal.

10. The controlled-kurtosis vibration controller of claim 1, further comprising a driver circuit connected to the actuator.

11. A vibration test system comprising:
a vibration table;
a unit under test disposed on the vibration table;
a transducer operably connected to the unit under test; and
a controlled-kurtosis controller, wherein the controlled-kurtosis controller comprises:
a Gaussian spectrum generator which generates a frequency-domain Gaussian distributed random spectrum;
a non-Gaussian spectrum generator which generates a frequency-domain non-Gaussian distributed random spectrum, wherein the non-Gaussian spectrum generator receives an input signal based on an input from the transducer, generates a scalar kurtosis estimate from an input signal from the transducer, compares the scalar kurtosis estimate to a target value, uses a result of the comparison to generate a time-domain envelope with attributes including amplitudes-of-transients and numbers-of-transients, uses the time-domain envelope to modulate a time-domain random signal, and transforms the modulated time-domain random signal into a frequency-domain non-Gaussian distributed random spectrum;
an inverse transfer function generator which modulates the respective spectra from the Gaussian and non-Gaussian spectrum generators, wherein the inverse transfer function generator receives the input signal and frequency-domain transforms the input signal into an input spectrum, the inverse transfer function generator receives a vibration controller output drive signal and frequency-domain transforms the vibration controller output drive signal into an output drive spectrum, the input spectrum and the output drive spectrum are processed to produce an estimate of cross power spectrum density, the output drive spectrum is processed to produce an estimate of drive auto power spectrum density, the estimate of cross power spectrum density and the estimate of drive auto power spectrum density are respectively averaged, and the respective averages are divided to generate a frequency-domain inverse transfer function; and
a synthesizer which generates the vibration controller output drive signal, wherein the Gaussian and non-Gaussian spectra are respectively multiplied by the frequency-domain inverse transfer function, and the respective multiplier outputs are summed and transformed into the vibration controller output drive signal, which is fed back to the vibration table as the excitation random signal.

12. The vibration test system of claim 11, further comprising a movable portion which vibrates the unit under test along at least one test axis based on the excitation random signal.

13. The vibration test system of claim 11, further comprising a driver actuator which vibrates the unit under test such that the input has a desired kurtosis value based on the excitation random signal fed back to the driver actuator from the controlled-kurtosis controller.

14. A method of providing an excitation random signal to an actuator in response to an input from a motion transducer, the method comprising:
generating successive frequency-domain Gaussian distributed random spectra;
generating successive frequency-domain non-Gaussian distributed random spectra, wherein generating successive frequency-domain non-Gaussian distributed random spectra comprises:
receiving successive windowed input signals based on input from the motion transducer;
generating successive scalar kurtosis estimates from the windowed input signals;
comparing successive scalar kurtosis estimates to a target value;
using results of the comparisons to generate successive time-domain envelopes with attributes including amplitudes-of-transients and numbers-of-transients;
using the successive time-domain envelopes to modulate a time-domain random signal; and
transforming the successive modulated time-domain random signals into
frequency-domain non-Gaussian distributed random spectra;
modulating the respective Gaussian and non-Gaussian spectra, wherein modulating the respective Gaussian and non-Gaussian spectra comprises:
receiving successive windowed input signals and frequency-domain transforming the input signals into successive input spectra;
receiving successive windowed vibration controller output drive signals and frequency-domain transforming the successive windowed vibration controller output drive signals into output drive spectra;
processing the successive windowed input spectra and output drive spectra to produce successive estimates of cross power spectrum density;
processing the output drive spectra to produce estimates of drive auto power spectrum density;
averaging successive estimates of cross power spectrum density;
averaging successive estimates of drive auto power spectrum density; and
dividing the respective averages to generate successive frequency-domain inverse transfer functions; and
generating the vibration controller output drive signal, wherein successive Gaussian and non-Gaussian spectra are respectively multiplied by successive frequency-domain inverse transfer functions, and the respective multiplier outputs are summed and transformed into successive vibration controller output drive signals, which are fed back to the actuator as the excitation random signal.
